(19) United States
(12) Patent Application Publication
(10) Pub. No.: US 2005/0138910 A1
(43) Pub. Date: Jun. 30, 2005

(54) Air filter with scavenging effect on free radicals in gaseous phase and its method of preparation

(76) Inventors: Peter Rohdewald, Munster (DE); Victor Ferrari, Geneva (CH)

Correspondence Address: Eric Sinn, Esq.;Mintz, Levin, Cohn, Ferris, Glovsky and Popeo, P.C, The Chrysler Center, 666 Third Avenue, 24th Floor, New York, NY, 10017, US

(21) Appl. No.: 10/999,615

(22) Filed: Nov. 29, 2004

Related U.S. Application Data
(63) Continuation-in-part of application No. 09/963,041, filed on Sep. 25, 2001, now Pat. No. 6,832,612.

(30) Foreign Application Priority Data
Oct. 16, 2000 (CN) 00130133A
Aug. 10, 2001 (WO) PCT/IB01/01862

(51) Int. Cl. B01D 39/04; B01D 39/16

(52) U.S. Cl. 55/528

(57) ABSTRACT

This invention relates to air filter components and apparatuses that act to scavenge gas phase free radicals present in polluted air. In specific aspects, the invention relates to filters that contain proanthocyanidins for scavenging the free radicals. The present invention is also directed to a method for producing air filter components and apparatuses with scavenging effects on gas phase free radicals.

### RELATED APPLICATIONS

This application is a continuation in part of U.S. patent application Ser. No. 09/963,041 filed Sep. 25, 2001, which is hereby incorporated by reference herein in its entirety.

### FIELD OF THE INVENTION

This invention relates to air filter components and apparatuses with a scavenging effect on gas phase free radicals contained in polluted air. In particular aspects, the invention utilizes filters that contain proanthocyanidins for scavenging the free radicals. The present invention is also directed to methods for producing air filter components and apparatuses with a scavenging effect on gas phase free radicals.

### BACKGROUND OF THE INVENTION

Inhaling gas phase free radicals is known to produce toxicological and pathological changes of the lung. Gas phase free radicals are widely known to be more harmful to the human body than solid phase free radicals. In part, this is a result of the high energy levels of gas phase free radicals. The lung may be damaged by inhaled gaseous and particulate matter. Free radicals, as contained as byproduct in smoke from combustion processes—e.g., internal combustion engines, heating and cooking with fuels, natural fires, tobacco smoking, car engines—are thought to be major contributors to lung diseases. Damage of the lung tissue by reactive free radicals may cause lung cancer, emphysema, chronic obstructive lung diseases, as well as cardiovascular disease. Smokers and non-smokers, exposed to second-hand smoke are especially at high risk for diseases caused by air pollution.

Reactive free radicals in gaseous phase, as contained in tobacco smoke, ozone smog and car emissions are important factors in bronchial hyperresponsivness and inflammatory lung injury. The free radicals attack cell constituents, either directly or indirectly, and are believed to be a factor in tobacco smoke-related diseases. Many parts of the body may be adversely affected by the gas phase free radicals including the lungs, mouth, pharynx, esophagus, heart and circulatory systems, and various organs. Free radicals may change the molecular structures of cell proteins and lipids and cause breaks in DNA sequences that lead to mutations, thereby increasing the risks of developing various types of cancers.

One common source of polluted air besides traffic emissions is side stream tobacco smoke affecting both the smoker and those in proximity of the smoker. A major health concern relates to the exposure of non-smokers, including infants and children, to tobacco smoke in the home and other location that derives from smokers. Individuals who do not smoke but are exposed to secondary side stream smoke may suffer the consequences of free radical damage from tobacco smoke. Tobacco smoke is the best investigated example of the contamination of air with free radicals.

It is well accepted that cigarette smoke contains an enormous amount of free radicals, including gas phase and solid phase free radicals. Most of the free radicals in cigarette smoke are instantaneous and unstable. The number of free radicals in the gas phase has been estimated to be 10¹⁵ per puff, which are primarily alkyl, alkoxyl, peroxyl, and nitric oxide (NO) free radicals. It is impossible to observe them directly with Electron Spin Resonance Spectroscopy (“ESR spectroscopy”) techniques. In order to observe gas phase free radicals, such as those present in cigarette smoke, a spin capture technique has to be employed. In this technique, gas phase free radicals are captured and then transformed into a spin adduct which can be tested via ESR spectroscopy. A spin collector (PBN) collects smoke gas phase free radicals, which are predominantly alkoxyl free radicals (RO●) and alkyl free radicals (R●).

Most of the gas phase free radicals in tobacco smoke are RO● and alkyl R● free radicals. Nitrogenous substances oxidize and produce great amounts of NO free radicals (NO●) in the process of cigarette burning. A reaction of NO● with oxygen results in the production of reactive NO₂● free radicals. An NO₂● free radical may react with olefin, a substance produced during cigarette burning, to form alkyl free radical RO●. RO● free radicals may attack cell membranes and cause lipid peroxidation. In turn, such lipid peroxidation may stimulate macrophages to release oxygen free radicals. Oxygen free radicals, on their own, may independently cause injury to cell constituents. They may poison cells and may contribute to causing lung cancer and heart disease together with the free radicals present in cigarette smoke. Such free radicals may also attack and inactivate pulmonary ∝-1 antiprotease, which prevents pulmonary injury by inactivating the tissue destroying elastase.

Thus, there is a vital need for air filter components and apparatuses to counter the effects of free radicals associated with air pollution.

### SUMMARY OF THE INVENTION

The examples herein demonstrate that filters comprising proanthocyanidins are highly effective in scavenging gas phase free radicals from air polluted with cigarette smoke. Thus, the air filter components and apparatuses of the invention can be used to remediate air flowing through the filter and thereby counteract the harmful effects of air pollution.

In one embodiment, the invention encompasses air filter components and apparatuses that comprise proanthocyanidins as defined herein. The air filter components may include proanthocyanidins attached to fiberglass, polyester, glass, plastic, paper, metal, plant material (e.g., cotton), or other filter material. The air filter components of the invention may be combined with other air purification systems such as those involving electrostatic charge, ozone discharge, and/or ultraviolet light.

In another embodiment, the invention encompasses methods for producing the disclosed air filter component and apparatus. The proanthocyanidins can be attached to filter material by spraying, dipping, absorbing, immersing, coating (e.g., curtain coating, slot coating, roll coating), wiping, brushing, dusting, or any combination thereof, or otherwise contacting the material with proanthocyanidins. The proanthocyanidin may be dissolved in a solvent such as water, alcohol, ethyl acetate, and the like. The proanthocyanidins can be added to the filter material as a solution, gel, powder, or other formulation. Preferably, proanthocyanidins are placed in solution, contacted with the air filter material, and the solvent is evaporated to leave a coating of the proanthocyanidins on the material.

In certain aspects, the air filter components and apparatuses of the invention can be used to counteract air pollution from tobacco smoke, vehicle emissions, combustion engines, heating and cooking fuels, natural or accidental fires, smog, and the like. Preferably, the air filters retain free radicals from the air. The air filter components can also be used to remove particulate matter from the air.

In particular aspects, the proanthocyanidins content in the filter may have a lower limit of about 0.0001%, about 0.001%, about 0.01%, about 0.1% or about 1% based on filter weight. In particular aspects, the proanthocyanidins content in the filter may have an upper limit of about 1%, about 2%, about 3%, about 5%, about 8%, about 10%, about 15%, about 20%, about 30%, about 40% or about 50% based on filter weight. In one preferred embodiment, the proanthocyanidins content in the filter has a lower limit of 0.0001% and an upper limit of 10% based on filter weight. In another preferred embodiment, the proanthocyanidin content in the filter has a lower limit of about 0.0007% and an upper limit of about 0.007% based on filter weight.

Other embodiments, objects, aspects, features, and advantages of the invention will be apparent from the accompanying description and claims.

### DETAILED DESCRIPTION OF THE INVENTION

Existing air filters act by removing particulate matter from air, such as allergens (e.g., pollen or molds), infective agents (e.g., bacteria or viruses), or dust particles (e.g., organic or inorganic matter), which can cause illnesses or inflammatory reactions. The present invention relates to an air filter that reduces the amount of free radicals in the air stream passing by means of a filter material comprising proanthocyanidins.

Components

The invention encompasses air filter components comprising proanthocyanidins, which are highly potent free radical scavengers. Proanthocyanidins include a group of plant polyphenols found in fruits with an astringent taste and in barks. For the purposes of this disclosure, the terms proanthocyanidin(s), oligomeric proanthocyanidin(s) (OPCs), and procyanidin(s) have the same meaning.

In accordance with the invention, proanthocyanidins may be extracted from plant material by conventional methods using water, ethanol or acetone/water mixtures as solvents and then concentrated through the processes of solvent evaporation, freeze-drying, or spray-drying to obtain proanthocyanidins. Particularly useful are polar, volatile solvents such as water, methanol, ethanol, i-propanol, propanol, acetone, diethyl-methylketone, ethylacetate, and methylacetate, which are able to dissolve proanthocyanidins. Extraction methods have been previously disclosed (see, e.g., U.S. Pat. No. 3,436,407; U.S. Pat. No. 4,698,360; U.S. Pat. No. 6,372,266, which are hereby incorporated by reference herein in their entireties). Solvent evaporation (i.e., drying) can be achieved at room temperature or accelerated by an increase in temperature.

The proanthocyanidin used in the examples herein is Pycnogenol® pine bark extract, which is produced and marketed by Horphag Research Limited. Pycnogenol® pine bark extract is derived from the bark of the French Maritime pine It includes a range amount of approximately 60% to 80% proanthocyanidins and other flavanols with free radical scavenging activity such as catechin, taxifolin, and phenolic acids. The proanthocyanidins contained in this extract have a chain length of about 2 to 12 monomeric units, wherein the monomeric units consist of catechin or epicatechin. Preferably, the proanthocyanidin compositions of the invention include 70% to 75% weight proanthocyanidins Methods for producing such compositions are known in the art.

Other proanthocyanidin-rich substances could also be used as free radical scavengers. These substances include, but are not limited to, extracts of the barks of pine trees, cones of cypresses trees, or grape seeds, or any combination thereof. Proanthocyanidins are particularly suitable for air filters because they are non-volatile substances. Proanthocyanidins possess a great tendency to stay adsorbed and remain inside the filter.

The air filters of the invention may be prepared, for example, by evenly spraying a proanthocyanidin composition over the filter material, and then drying the filter material. Alternatively, the filter material can be dipped into a proanthocyanidin composition. The proanthocyanidin composition can be absorbed into filter material, or coated onto the surface of the filter material. In various aspects, the proanthocyanidin composition can be formulated into a liquid, gel, aerosol, suspension, or ultra-fine powder. Preferably, the proanthocyanidin composition used for the air filter excludes L-glutathione and/or a source of selenium (e.g., L-selenomethionine or L-selenocysteine). More preferably, the proanthocyanidin composition is substantially free of L-glutathione.

The air filter components may include proanthocyanidins attached to fiberglass, polyester, or other synthetic materials. Preferred synthetic materials include nylon, rayon, polyurethane, polypropylene, polyethylene, polyolefin, polycarbonate, polyamide, and poly(4-methyl-pentene). The air filter material may be a permeable nylon such as Velro™. HEPA (high efficiency particulate air filter) or paper materials can also be employed using known methods.

The air filter material can be any type of texture. If the material is a woven fabric, for example, plain weave, twill weave, gauze elastic webbing, gauze weave, leno weave, etc., may be adopted. If the material is a knitted fabric, for example, tricot knitting, milanese knitting, raschel knitting may be adopted. Preferably a honeycomb weave structure is used for its elasticity, flexibility, permeability, dust removability and dimensional stability required for the air filter (see, e.g., U.S. Pat. No. 6,540,807).

The air filter material can be comprised of a nonwoven fibrous web (see, e.g., U.S. Pat. No. 6,277,176). The filter web could be formed of the split fibrillated fibers as described in U.S. Pat. No. 30,782. These charged fibers can be formed into a nonwoven web by conventional means and optionally joined to a supporting scrim such as disclosed in U.S. Pat. No. 5,230,800 forming an outer support layer. The support scrim can be a spunbond web, a netting, a Claf web, or the like. Alternatively, the nonwoven fibrous filter web can be a melt blown microfiber nonwoven web, such as disclosed in U.S. Pat. No. 4,917,942, which can be joined to a support layer during web formation as disclosed in that patent, or subsequently joined to a support web in any conventional manner.

The filter material may be disposable, washable/reusable, flat, pleated, deep pleated, close pleated, or electrostatically charged. The material can be charged by known methods e.g., by use of corona discharge electrodes, high-intensity electric fields or by tribo-charging (e.g., as described in U.S. Pat. No. 4,798,850) where fibers of differing dielectric properties are rubbed together, e.g., during formation of the material, creating mutual charges on the fibers.

In other aspects, the air filter components can include proanthocyanidins affixed to glass, plastic, metal, or other similar material. The proanthocyanidins can be added to the components as a coating with or without an adhesive layer. Methods for coating components with polymers are well known in the art and can be adopted for use with proanthocyanidins.

The air filter components of the invention may include activated charcoal, potassium pernanganate, an anti-bacterial agent, an antifungal agent, or an antiviral agent. The components can alternatively include an antioxidant, a UV-absorbent, a light stabilizer, a dispersant, a lubricant, an antistatic agent, a pigment, an inorganic filler, a flame retardant, a cross linking agent, a foaming agent, a nucleus forming agent, or other additives.

Apparatuses

The invention further encompasses air filter apparatuses that are capable of effectively scavenging free radical components from passing air by use of proanthocyanidins. The ability of the air filter component to counteract free radicals further provides a safe and convenient air filter component that can be easily removed from a filtration or ventilation system and discarded without the fear of residual contamination. In certain aspects, the invention provides an economically efficient air filter apparatus that can employ disposable filters that allow for quick and easy replacement.

The air filter apparatus can include a water chamber, e.g., a humidifying chamber filled with actively circulating air. The apparatus can be also used with a corona discharge system to generate a corona electric arc or spark. Alternatively, the air filter apparatus can include systems for generating ozone and/or ultraviolet (UV) light. The UV lamps can employ broad spectrum radiation (e.g., 100 to 300 nm) or specific wavelengths (e.g., 185 nm or 254 nm). Preferred are germicidal UV lamps, e.g., UV-C. In one aspect, the apparatus can employ a UV tube to target a hydrated or non-hydrated catalyst cell to produce low-level ozone.

In another aspect, the air filter of the invention may be part of a respiratory system such as, for example, a respiratory mask (gas mask, surgical mask, and the like). The mask may be useful in environments where the air is substandard, such as, for example in a manufacturing environment or in the presences of excessive smoke or pollution (e.g., a mask for fireman). In addition, the filter may be used as an in-line filter to treat compressed gases or air before use.

In many air filter apparatuses (e.g., air conditioners, room air filters, industrial air filters), air is recirculated through the filter multiple times during use. Thus, it is not essential or necessary for 100% of the air filter material to comprise proanthocyanidins. Proanthocyanidins may be applied to less than 100% of the surface or content of the air filter material. Multiple passages through the air filter component may be used to provide sufficient proanthocyanidin treatment.

One advantage of this invention is the ease in manufacturing. For example, in contacting proanthocyanidins with the filter, it is desirable but not essential to distribute proanthocyanidins throughout or allover the filter. It is sufficient, e.g., to spot spray proanthocyanidins onto one or more regions of the air filter material, or to dip one part of the filter material into a proanthocyanidin composition. Further, an air filter component can be made where only a part of the material comprises proanthocyanidins. In a particular, in a filter made of woven material with horizontal and vertical threads, one set of threads can be treated with proanthocyanidins, while the other set(s) remain untreated. In another example, proanthocyanidin may be coated onto pellets, beads, or microparticles that are dispersed within the filter material of bulk fiber or paper and the like.

In various aspects, the air filter apparatuses of the invention can be used to counteract various forms of air pollution, including cigarette smoke, cigar smoke, pipe smoke, car emissions, bus emissions, truck emissions, coal emissions, petroleum emissions, natural gas emissions, factory emissions, smoke from fires, and city smog. The disclosed air filter apparatuses can be used in numerous settings, such as public or private buildings, e.g., homes, offices, schools, and hospitals. The apparatuses can also be used in various vehicles, including cars, trucks, busses, trains, boats, and planes.

### EXAMPLES

The examples are presented in order to more fully illustrate the preferred embodiments of the invention. These examples should in no way be construed as limiting the scope of the invention, as encompassed by the appended claims.

The following examples demonstrate the successful utilization of a cigarette filter produced by the disclosed methods. The efficacy of the cigarette filter in removing a substantial amount of free radicals from concentrated tobacco smoke demonstrates the application of the air filters of the invention to remove free radicals from polluted air in rooms exposed to cigarette smoke, ozone smog or car emissions, and other such conditions.

### Example 1

Proanthocyanidins (standardized French maritime pine bark extract Pycnogenol®, containing 70% procyanidins) were dissolved in ethanol 96% V/V, and evenly sprayed over the surface of the filter material, cellulose acetate fibers. The ethanol was evaporated and the coated filter material was processed into cigarette filter as is well known in the art. Testing for the effectiveness of the improved filter was performed as follows.

Unfiltered cigarettes were used as reference cigarettes. ESR techniques were used to test the gas phase radicals respectively contained in the smoke of the cigarettes. The amount of free radicals in the filter of the present invention was compared with the amount in standard unfiltered cigarettes. Efficacy of the improved filter was conducted by using a smoking device to imitate human's smoking at a flow rate of about 400 ml/min, inhaling once for two seconds, one minute apart. The ESR testing conditions included: X band, 20 mW microwave power, 100 KHz modulation frequency and 1 G modulation amplitude.

The free radical scavenging rate (E %) was calculated by the following formula:
E=(Hₓ×100/H₀)−100

where H₀ represents the peak intensity of the reference system, and Hₓ represents the peak intensity of scavenger containing samples.

Cigarettes were produced with an improved filter including a proanthocyanidin content of about 0.001077% based on the weight of the filter material.

Using the described method, cigarettes with the improved filter were tested in accordance with the procedure explained above and the rate of free radical scavenging was calculated by the above-mentioned free radical scavenging rate formula. The gas phase free radical scavenging rate was calculated as 22.6%. Detailed results are shown Table 1 (below).

### Example 2

Cigarettes were produced with an improved filter having a proanthocyanidin content of about 0.002154% based on the weight of the filter material. Using the method of Example 1, cigarettes with the improved filter were tested in accordance with the procedure explained above and calculated by the above-mentioned free radical scavenging rate formula. The gas phase free radical scavenging rate was calculated as 27.6%. Detailed results are shown in Table 2 (below).

### Example 3

Cigarettes were produced with an improved filter having a proanthocyanidin content of about 0.00359% based on the weight of the filter material. Using the method of Example 1, cigarettes with the improved filter were tested in accordance with the procedure explained above and calculated by the above-mentioned free radical scavenging rate formula. The gas phase free radical scavenging rate was calculated as 29.1%. Detailed results are shown in Table 3 (below).

### Example 4

Cigarettes were produced with an improved filter having a proanthocyanidin content of about 0.00718% based on the weight of the filter material. Using the method of Example 1, cigarettes with the improved filter were tested in accordance with the procedure explained above and calculated by the above-mentioned free radical scavenging rate formula. Calculated by the above-mentioned free radical scavenging rate formula, the gas phase free radical scavenging rate was determined as 20%. Detailed results are shown in Table 4 (below).

As shown by these examples, proanthocyanidin content in filter within a range of about 0.001077% to about 0.00718% (based on the weight of the filter material), produces a high scavenging effect on gas phase free radicals in tobacco smoke. The tests indicate that the gas phase radical scavenging effect is at its maximum when the proanthocyanidin content in the filter is about 0.00359%.

### Example 5

The reduction of free radicals in tobacco smoke also reduces the mutagenic action of tobacco smoke and markedly increased the lifetime of animals exposed to filtered smoke. In one study, mice were exposed to lethal amounts of cigarette smoke in a polyacryl glass cabin (35.6 cm×35 cm×20 cm) with two 1.5 cm² holes, one located on top of the cabin for ventilation and another located at the bottom for introducing the gas phase (D. Zhang et al., Toxicology and Industrial Health 2002, 18: 215-224). Forty (40) mice were randomly divided into 4 groups. Mice in group 1 were treated with smoke from cigarettes with standard filter. Mice in groups 2 and 3 were treated with smoke from cigarettes with filters containing 0.001077% and 0.00359% proanthocyanidin, pine bark extract respectively. Mice in group 4 served as control and were not treated with cigarettes smoke. Cigarette smoke was introduced into a cabin containing one group of 10 mice at a time. The time and number of cigarettes used were recorded until the lethal endpoint was reached. All deceased mice were subject to biopsies and histopathological examination.

In the control group (cigarette filters without proanthocyanidins), an obvious congestion and hemorrhage in lung tissue was observed in 80% of mice. Also, a vasodilation and congestion of small blood vessels in kidneys and slight vasodilation and congestion of central veins in livers were found. The presence of 0.00359% proanthocyanidin pine bark extract in cigarette filters significantly increased the survival time and reduced the acute toxicity of cigarette smoke by 70.5%. In the absence of proanthocyanidins in the cigarette filter, the mice died after exposure to the smoke of 8 cigarettes. With 0.00359% proanthocyanidin pine bark extract in the filters, mice died after exposure to the smoke of 14 cigarettes.

Based on this example, the content of the above-mentioned free radical scavenge contained in a filter may range from about 0.001077% to about 0.00718% of the weight of the filter material. The scavenger is highly effective in this range.

All of the above examples demonstrate the ability of proanthocyanidins in a filter to inactivate free radicals from concentrated air pollution such as that found in cigarette smoke.

TABLE 1
0.001077% proanthocyanidin filter's scavenging
effect on gas phase free radical in smoke

| H₀ of Control Group | | | | Hₓ of Application Example 1 | | | |
|---|---|---|---|---|---|---|---|
| 4.1 | 4.6 | 4.5 | 4.5 | 2.0 | 3.0 | 4.3 | 5.1 |
| 7.5 | 4.8 | 8.0 | 5.0 | 4.5 | 7.5 | 4.7 | 4.0 |
| 4.0 | 8.0 | 13.5 | 8.0 | 5.0 | 3.5 | 9.0 | 3.5 |
| 6.9 | 6.2 | 4.7 | 5.6 | 7.8 | 7.9 | 7.4 | 5.1 |
| 5.7 | 6.9 | 7.0 | 7.8 | 5.0 | 3.9 | 4.9 | 5.7 |
| 7.4 | 10.0 | 6.5 | 5.7 | 5.1 | 6.7 | 7.1 | 6.6 |
| 6.7 | 6.8 | 7.4 | 8.0 | 7.3 | 7.0 | 6.4 | 6.3 |
| 7.1 | 6.6 | 8.9 | 9.0 | 5.0 | 6.9 | 6.1 | 4.2 |
| 11.5 | 17.0 | 7.8 | 7.0 | 6.5 | 7.0 | 10.0 | 11.0 |
| 6.6 | 7.1 | 9.0 | 8.8 | 11.5 | 6.2 | 6.4 | 6.5 |
| 6.3 | 8.7 | 7.6 | 5.0 | 7.7 | 8.0 | 6.0 | 7.0 |
| 7.0 | 7.5 | 6.1 | 5.0 | 4.1 | 7.6 | 5.6 | 6.0 |
| 5.5 | 5.5 | 6.5 | 8.5 | 7.5 | 5.0 | 4.0 | 4.1 |
| 8.5 | 9.5 | 8.5 | 10 | 4.0 | 5.0 | 4.0 | 4.05 |
| 12 | 9.0 | 8.0 | 7.0 | 4.0 | 5.5 | 6.0 | 4.6 |
| 10 | 11.0 | 10.5 | 8.9 | 7.3 | 5.5 | 7.5 | 7.6 |
| 9.2 | 9.5 | 10.0 | 7.0 | 4.8 | 5.7 | 6.0 | 6.6 |
| 10.5 | 8.0 | | | 8.0 | 5.0 | 8.0 | |

| | | |
|---|---|---|
| Mean value | 7.22 | 5.97 |
| Standard error | 2.28 | 1.90 |
| Scavenging effect | | 22.6% |
| Probality of error (P value) | | <0.05% |

TABLE 2
0.002154% proanthocyanidin filter's scavenging effect on gas
phase free radical in smoke

| H₀ of Control Group | | | | Hₓ of Application Example 2 | | | |
|---|---|---|---|---|---|---|---|
| 18.5 | 6.5 | 9.9 | 5.2 | 12.0 | 6.7 | 5.3 | 4.4 |
| 18.5 | 6.8 | 7.3 | 5.8 | 12.0 | 5.6 | 6.0 | 2.7 |
| 16.5 | 5.3 | 7.5 | 7.2 | 11.0 | 6.1 | 7.5 | 6.5 |
| 15.5 | 5.9 | 7.5 | 9.0 | 10.3 | 5.7 | 6.0 | 4.2 |
| 15.2 | 5.8 | 7.0 | 8.8 | 10.0 | 6.7 | 5.2 | 6.0 |
| 15.0 | 7.7 | 6.1 | 8.5 | 10.0 | 7.0 | 5.4 | 6.2 |
| 15.0 | 5.5 | 6.5 | 7.4 | 9.9 | 7.1 | 4.6 | 6.1 |
| 13.7 | 5.4 | 8.0 | 10.5 | 9.5 | 7.8 | 6.0 | 7.0 |
| 13.3 | 5.8 | 6.6 | 8.0 | 9.0 | 7.8 | 3.0 | 7.0 |
| 13.0 | 7.8 | 7.0 | 6.6 | 8.2 | 5.1 | 4.2 | 6.1 |
| 12.0 | 6.2 | 9.0 | 6.5 | 8.0 | 7.1 | 4.5 | 3.9 |
| 11.2 | 7.9 | 8.6 | 5.7 | 8.0 | 5.1 | 4.0 | 6.0 |
| 10.0 | 6.0 | 6.0 | 7.2 | 7.0 | 5.6 | 3.7 | 7.2 |
| 8.0 | 6.5 | 6.5 | 7.3 | 6.5 | 6.8 | 5.4 | 6.7 |
| 9.0 | 6.0 | 5.0 | 7.8 | 7.2 | 4.2 | 4.2 | 3.2 |
| 7.8 | 7.1 | 6.8 | 7.0 | 6.0 | 8.0 | 6.7 | 4.1 |
| 6.7 | 6.1 | 5.9 | 7.4 | 7.1 | 5.3 | 6.0 | 4.5 |
| 18.5 | 5.5 | 14.2 | 5.5 | 10.5 | 11.2 | 10.5 | 8.0 |
| 6.5 | 6.4 | 6.0 | 6.0 | 3.6 | 8.4 | 5.1 | 4.7 |
| 6.7 | 6.0 | 7.4 | 7.8 | 4.0 | 5.5 | 5.7 | 4.5 |
| 8.0 | 16.0 | 16.0 | 17.0 | 12.0 | 10.5 | 10.5 | 6.0 |
| 11.8 | 8.0 | 9.0 | 9.5 | 11.8 | 5.0 | 5.2 | 5.0 |
| 6.0 | 7.6 | 7.8 | 10.5 | 7.7 | 7.0 | 6.0 | 5.0 |
| 6.0 | 7.4 | 8.2 | 7.9 | 6.5 | 3.5 | 6.0 | 4.0 |
| 6.0 | 5.0 | 6.2 | 9.7 | 5.2 | 6.0 | 8.0 | 9.0 |
| 6.7 | 5.6 | 6.0 | 10.9 | 6.9 | 5.6 | 2.3 | 5.0 |
| 5.7 | 6.7 | 7.0 | 9.8 | 3.7 | 6.7 | 2.7 | 5.0 |
| 7.8 | 9.8 | 5.7 | 8.1 | 2.0 | 2.2 | 6.2 | 8.2 |
| 5.1 | 8.2 | 5.6 | 8.9 | 3.8 | 4.6 | 2.9 | 6.8 |
| 5.3 | 8.0 | 7.5 | 9.0 | 4.3 | 2.5 | 2.6 | 5.0 |
| 6.5 | 8.8 | 5.3 | 9.6 | 5.2 | 5.4 | 4.6 | 6.0 |
| 5.8 | 7.7 | 8.5 | 9.8 | 3.0 | 4.2 | 4.5 | 5.2 |
| 5.8 | 7.8 | 6.2 | 7.9 | 5.2 | 3.7 | 5.4 | 4.4 |
| 9.2 | 8.0 | 8.5 | 9.9 | 2.7 | 6.5 | 4.2 | 5.0 |
| 9.8 | 8.0 | 9.5 | 10.5 | 6.5 | 6.1 | 2.0 | 4.5 |

| | | |
|---|---|---|
| Mean value | 8.30 | 6.01 |
| Standard error | 2.92 | 2.12 |
| Scavenging effect | | 27.6% |
| Probality of error (P value) | | <0.01% |

TABLE 3
0.00359% proanthocyanidin combining filter's scavenging
effect on gas phase free radical in smoke

| H₀ of Control Group | | | | Hₓ of Application Example 3 | | | |
|---|---|---|---|---|---|---|---|
| 7.9 | 15.0 | 5.8 | 6.7 | 5.4 | 2.0 | 6.2 | 6.5 |
| 8.7 | 18.0 | 5.9 | 6.0 | 5.8 | 10.5 | 7.0 | 6.8 |
| 9.7 | 15.0 | 6.2 | 7.4 | 4.9 | 11.0 | 6.2 | 7.0 |
| 7.0 | 19.0 | 6.1 | 7.8 | 7.0 | 6.6 | 5.0 | 7.0 |
| 8.6 | 16.5 | 5.0 | 8.0 | 8.0 | 10.3 | 3.5 | 3.9 |
| 8.8 | 7.3 | 6.3 | 16.0 | 8.0 | 7.0 | 6.6 | 2.5 |
| 9.4 | 8.0 | 5.2 | 16.0 | 8.7 | 6.0 | 4.1 | 8.5 |
| 10.1 | 12.0 | 7.1 | 17.0 | 6.7 | 8.6 | 2.6 | 4.1 |
| 7.0 | 11.2 | 7.5 | 11.8 | 8.7 | 9.6 | 2.6 | 4.8 |
| 7.4 | 13.0 | 7.6 | 8.0 | 6.5 | 5.8 | 1.2 | 5.2 |
| 8.7 | 13.3 | 6.5 | 9.0 | 5.6 | 1.8 | 1.9 | 5.5 |
| 9.6 | 11.2 | 6.9 | 6.2 | 6.7 | 11.0 | 5.9 | 5.0 |
| 6.1 | 18.5 | 6.8 | 6.0 | 7.6 | 10.7 | 4.6 | 6.1 |
| 5.9 | 15.2 | 5.9 | 7.6 | 5.5 | 9.8 | 4.0 | 10.0 |
| 6.6 | 15.5 | 6.2 | 7.8 | 5.5 | 9.7 | 4.7 | 7.4 |
| 6.2 | 10.0 | 18.5 | 5.5 | 6.0 | 10.0 | 5.4 | 10.0 |
| 6.3 | 13.7 | 21.5 | 6.0 | 5.0 | 9.0 | 3.0 | 8.0 |
| 7.4 | 7.2 | 14.2 | 7.4 | 6.7 | 6.7 | 6.2 | 5.0 |
| 9.1 | 6.2 | 6.5 | 8.2 | 6.6 | 5.0 | 6.4 | 8.0 |
| 6.4 | 6.0 | 6.6 | 6.0 | 7.1 | 5.8 | 5.6 | 9.8 |
| 5.0 | 6.2 | 6.2 | 6.9 | 8.8 | 3.0 | 4.4 | 4.5 |
| 9.2 | 9.5 | 6.0 | 8.2 | 5.7 | 5.8 | 5.7 | 8.5 |
| 10.3 | 8.1 | 9.0 | 7.5 | 7.7 | 9.5 | 7.5 | 8.2 |
| 7.2 | 6.2 | 5.8 | 5.9 | 5.0 | 6.2 | 7.0 | 6.2 |
| 8.2 | 8.1 | 5.0 | 8.3 | 5.0 | 3.5 | 6.6 | 4.1 |
| 5.3 | 7.7 | 7.5 | 7.6 | 2.6 | 2.6 | 1.2 | 1.9 |
| 8.5 | 8.9 | 6.8 | 4.7 | 5.9 | 4.6 | 4.0 | 4.7 |
| 5.9 | 6.2 | 7.9 | 8.0 | 5.4 | 3.0 | 5.4 | 5.8 |
| 9.7 | 7.0 | 8.6 | 8.0 | 4.9 | 7.0 | 6.0 | 6.0 |
| 8.8 | 8.2 | 10.1 | 7.0 | 6.2 | 6.7 | 6.7 | 6.7 |
| 7.5 | 8.7 | 9.6 | 6.1 | 6.5 | 5.6 | 6.7 | 7.6 |
| 5.9 | 8.6 | 6.2 | 6.3 | 5.5 | 5.5 | 6.0 | 5.0 |
| 7.4 | 9.1 | | | 6.7 | 6.6 | | |

| | | |
|---|---|---|
| Mean value | 8.62 | 6.11 |
| Standard error | 3.39 | 2.17 |
| Scavenging effect | | 29.1% |
| Probality of error (P value) | | <0.01% |

TABLE 4
0.00718% proanthocyanidin combining filter's scavenging
effect on gas phase free radical in smoke

| H₀ of Control Group | | | | Hₓ of Application Example 4 | | | |
|---|---|---|---|---|---|---|---|
| 6.6 | 8.5 | 7.8 | 6.6 | 1.2 | 6.5 | 5.8 | 1.2 |
| 6.6 | 6.0 | 8.0 | 5.6 | 5.8 | 6.0 | 11.1 | 5.9 |
| 8.6 | 5.4 | 16.0 | 8.6 | 4.0 | 4.8 | 12.0 | 4.0 |
| 6.9 | 6.1 | 16.0 | 5.9 | 4.9 | 7.2 | 11.8 | 4.9 |
| 5.8 | 6.1 | 17.0 | 5.3 | 5.2 | 6.2 | 11.0 | 5.2 |
| 6.4 | 7.8 | 11.8 | 6.4 | 4.5 | 6.6 | 12.5 | 4.5 |
| 7.1 | 7.8 | 8.0 | 5.1 | 8.0 | 5.7 | 9.0 | 6.0 |
| 8.2 | 5.7 | 9.0 | 8.2 | 6.2 | 4.7 | 6.7 | 6.2 |
| 6.3 | 6.0 | 6.2 | 6.3 | 5.9 | 5.0 | 5.2 | 5.9 |
| 6.7 | 8.5 | 6.0 | 8.1 | 5.2 | 6.0 | 7.0 | 5.2 |
| 5.7 | 8.0 | 7.6 | 5.2 | 5.2 | 6.0 | 7.0 | 5.3 |
| 6.9 | 5.3 | 7.8 | 6.9 | 5.1 | 6.3 | 6.5 | 5.1 |
| 6.2 | 5.8 | 5.5 | 6.2 | 5.1 | 2.7 | 4.0 | 5.1 |
| 7.8 | 7.1 | 6.0 | 8.8 | 6.0 | 6.0 | 8.0 | 6.0 |
| 6.8 | 7.2 | 7.4 | 8.8 | 4.0 | 6.9 | 5.0 | 4.0 |
| 5.8 | 5.9 | 8.2 | 8.6 | 5.6 | 2.9 | 5.4 | 5.6 |
| 6.7 | 6.5 | 6.0 | 8.1 | 4.1 | 7.0 | 5.5 | 4.1 |
| 5.7 | 8.1 | 5.0 | 5.2 | 4.7 | 5.8 | 5.0 | 4.7 |
| 5.6 | 5.0 | 6.2 | 5.0 | 5.0 | 6.0 | 4.3 | 5.2 |
| 5.9 | 6.5 | 6.2 | 6.7 | 5.2 | 4.3 | 5.0 | 5.2 |
| 5.9 | 6.0 | 6.0 | 5.4 | 5.6 | 5.7 | 9.5 | 5.1 |
| 7.2 | 6.5 | 9.2 | 5.7 | 4.3 | 5.0 | 10.7 | 5.1 |
| 7.5 | 6.7 | 9.5 | 5.6 | 4.9 | 6.6 | 9.5 | 4.4 |
| 6.5 | 18.5 | 6.0 | 5.9 | 4.9 | 12.5 | 7.5 | 5.0 |
| 6.7 | 21.5 | 5.3 | 7.2 | 6.1 | 10.7 | 8.2 | 5.2 |
| 7.3 | 14.2 | 7.3 | 7.5 | 5.8 | 11.5 | 8.0 | 5.6 |
| 7.6 | 21.5 | 8.2 | 6.5 | 7.7 | 8.7 | 6.0 | 4.3 |
| 5.8 | 6.5 | 10.3 | 6.7 | 6.1 | 4.8 | 6.4 | 4.9 |
| 6.4 | 6.4 | 8.1 | 7.3 | 5.6 | 2.0 | 4.9 | 6.0 |
| 6.6 | 6.0 | 9.0 | 7.6 | 4.9 | 6.0 | 5.8 | 5.6 |
| 6.3 | 6.0 | 7.4 | 7.8 | 6.5 | 5.6 | 7.1 | 6.1 |
| 7.3 | 6.7 | 6.7 | 7.8 | 7.1 | 4.0 | 5.6 | 4.9 |
| 7.8 | 6.0 | 6.0 | 8.5 | 7.1 | 6.0 | 3.5 | 6.0 |

| | | |
|---|---|---|
| Mean value | 7.45 | 5.96 |
| Standard error | 2.79 | 2.02 |
| Scavenging effect | | 20.0% |
| Probality of error (P value) | | <0.05% |

The details of one or more embodiments of the invention have been set forth in the accompanying description above. Although any methods and materials similar or equivalent to those described herein can be used in the practice or testing of the present invention, the preferred methods and materials are now described. Other features, objects, and advantages of the invention will be apparent from the description and from the claims.

In the specification and the appended claims, the singular forms include plural referents unless the context clearly dictates otherwise. Unless defined otherwise, all technical and scientific terms used herein have the same meaning as commonly understood by one of ordinary skill in the art to which this invention belongs. Unless expressly stated otherwise, the techniques employed or contemplated herein are standard methodologies well known to one of ordinary skill in the art.

All patents and publications cited in this specification are hereby incorporated by reference herein, including the previous disclosure provided by U.S. patent application Ser. No. 09/963,041 filed Sep. 25, 2001.

1. An air filter that includes proanthocyanidins as filtering ingredients, the filtering ingredients being in an amount effective for scavenging gas phase free radicals present in polluted air.

2. The air filter of claim 1, wherein the air filter retains free radicals from polluted air.

3. The air filter of claim 1, wherein the proanthocyanidins are selected from the group consisting of proanthocyanidins from plant extracts, proanthocyanidins from bark extracts of pine trees, proanthocyanidins from extracts of cones of cypress trees, proanthocyanidins from extracts of grape seeds, and any combination thereof.

4. The air filter of claim 1, wherein the air filter includes proanthocyanidins in an amount of about 0.0001% to about 20% of the air filter weight.

5. An air filter apparatus, comprising an air filter that includes proanthocyanidins as filtering ingredients, the filtering ingredients being in an amount effective for scavenging gas phase free radicals present in polluted air.

6. The air filter apparatus of claim 5, wherein the air filter retains free radicals from polluted air.

7. The air filter apparatus of claim 5, wherein the proanthocyanidins are selected from the group consisting of proanthocyanidins from plant extracts, proanthocyanidins from bark extracts of pine trees, proanthocyanidins from extracts of cones of cypress trees, proanthocyanidins from extracts of grape seeds, and any combination thereof.

8. The air filter apparatus of claim 5, wherein the air filter includes proanthocyanidins in an amount of about 0.0001% to about 20% of the air filter weight.

9. A method for producing an air filter that includes proanthocyanidins as filtering ingredients, comprising: contacting a composition comprising proanthocyanidins with at least a portion of air filter material, and depositing the proanthocyanidins in or on the air filter material, thereby producing the air filter.

10. The method of claim 9, wherein the composition is a solution comprising proanthocyanidins dissolved in about 95% ethanol.

11. The method of claim 9, wherein the contacting comprises spraying, dipping, absorbing, immersing, coating, wiping, brushing, dusting, or any combination thereof.

12. The method of claim 9, wherein the proanthocyanidins are deposited substantially evenly over the air filter material.

13. The method of claim 9, wherein the proanthocyanidins are selected from the group consisting of proanthocyanidins from plant extracts, proanthocyanidins from bark extracts of pine trees, proanthocyanidins from extracts of cones of cypress trees, proanthocyanidins from extracts of grape seeds, and any combination thereof.

14. The method of claim 9, wherein the air filter component after drying includes proanthocyanidins in an amount of 0.0001% to 20% of the air filter component weight.

15. The method of claim 10, wherein the contacting comprises dipping the air filter material into the proanthocyanidin solution and removing a surplus of the solution.

16. The method of claim 15, which further comprises drying the air filter material.
